(19) United States
(12) Patent Application Publication
(10) Pub. No.: US 2014/0377021 A1
(43) Pub. Date: Dec. 25, 2014

(54) Saw blade having a small saw tooth

(71) Applicant: ALBERT KNEBEL GMBH & CO. KG HOLDING, Balingen (DE)

(72) Inventor: Alexander Knebel, Balingen (DE)

(73) Assignee: ALBERT KNEBEL GMBH & CO. KG HOLDING, Balingen (DE)

(21) Appl. No.: 14/287,407

(22) Filed: May 27, 2014

(30) Foreign Application Priority Data
Jun. 21, 2013 (DE) 20 2013 102 690.5

(51) Int. Cl. B23D 61/04; B23C 5/08; B23D 61/14

(52) U.S. Cl. CPC B23D 61/04; B23D 61/14; B23C 5/08; B23C 2210/16; B23C 2210/32
USPC 407/52; 83/835; 83/839; 83/661

(57) ABSTRACT

A saw tooth for a saw blade that is attached in a longitudinal direction thereof on the saw blade body to extend away, at least in part, from the saw blade body. The saw tooth is formed with a cutting-face part having a cutting face, a height of which extends in the longitudinal direction and a width of which extends perpendicularly to the longitudinal direction. The width of the cutting face is greater than a height of the cutting face.

### CROSS-REFERENCE TO A RELATED APPLICATION

The invention described and claimed hereinbelow is also described in German Priority Document DE 20 2013 102690.5, filed on Jun. 21, 2013. The German Priority Document, the subject matter of which is incorporated herein by reference, provides the basis for a claim of priority of invention under 35 U.S.C. 119(a)-(d).

### BACKGROUND OF THE INVENTION

The invention relates to a saw tooth for a saw blade that is attached in the longitudinal direction thereof on the saw blade body so as to extend away, at least in part, from a saw blade body of the saw blade. The inventive saw tooth comprises a cutting-face part having a cutting face, the height of which extends in the longitudinal direction and the width of which extends perpendicularly to the longitudinal direction.

It is known to equip saw blade bodies of saw blades with saw teeth. After thusly equipping the saw blade body, it is necessary to perform sharpening-, laser-, and/or erosion processing in order to impart the final shape and sharpness to the saw teeth. In order to permit this processing to be carried out in a short period of time, it is advantageous to design the saw teeth to be as small as possible.

Small saw teeth have the further advantage of being relatively quiet, in particular in the case of rapidly rotating circular saw blades. Furthermore, small saw teeth have greater stability against lateral deflection and axial oscillating motions, thereby making it possible to improve cutting quality and extend the downtime of the saw blade.

Finally, saw teeth are often provided with expensive coatings, in particular diamond-based coatings. A small amount of coating material is used in the production of small saw teeth, thereby enabling the saw teeth to be produced in a low-cost manner.

With small saw teeth, however, there is a risk that the saw teeth will not be adequately adhered to the saw blade body, since there is only a small connection surface available between the individual saw teeth and the saw blade body, and the stability of the connection greatly depends on the size of the connection surface.

### SUMMARY OF THE INVENTION

The present invention overcomes the shortcomings of known arts, such as those mentioned above.

To that end, the present invention provides a saw tooth and a saw blade that permit a good connection to be established between the saw tooth and the saw blade body even in the case of small dimensions of the saw tooth.

In an embodiment, the invention provides a saw blade that is attached in the longitudinal direction thereof on the saw blade body so as to extend away, at least in part, from a saw blade body of the saw blade. The saw tooth comprises a cutting-face part having a cutting face, the height of which extends in the longitudinal direction and the width of which extends perpendicularly to the longitudinal direction. The width of the cutting face is greater than the height of the cutting face.

Given that the height is less than the width, the leverage acting on the saw tooth is low. The saw tooth is securely attached to the saw blade, therefore.

In an embodiment, the saw tooth has an attachment projection which extends away from the cutting face in the longitudinal direction. The attachment projection is fixedly anchored on the saw blade body, thereby making it possible to produce a very stable connection of the saw tooth to the saw blade. The attachment projection also may be referred to as an “extension”, while the cutting-face part having the cutting face is the “working part” of the saw tooth.

The attachment projection is designed having any length in the longitudinal direction. The attachment projection may be larger in the longitudinal direction than in the width. Preferably, the attachment projection is larger in the longitudinal direction than in the height of the cutting face. As a result, the leverage acting on the cutting tooth can be well compensated for.

The width of the attachment projection may be smaller than the width of the cutting face. The result thereof is an attachment projection of the saw tooth having the overall shape of a peg. Such an attachment projection is inserted into an attachment recess of the saw blade.

The saw tooth has a thickness extending perpendicularly to the height of the cutting face and perpendicularly to the width of the cutting face. The thickness of the cutting-face part corresponds to the thickness of the attachment projection. In other words, the saw tooth has a uniform thickness as viewed in the cutting direction. The saw tooth is therefore particularly easy to produce.

Alternatively, the thickness of the cutting-face part may be greater than the thickness of the attachment projection. As a result, a stop is formed between the attachment projection and the cutting-face part of the saw tooth, up to which the saw tooth can be inserted into an attachment recess of the saw blade. During sawing, the saw tooth is supported against the saw blade body by a stop.

At least one transition between the cutting-face part and the attachment projection is rounded. By such rounding, it is possible to prevent an unwanted notch effect and, therefore, prevent the risk of crack formation. The rounding is preferably provided on one side of the saw tooth, the surface of which is perpendicular to the cutting face.

Preferably, all transitions between the cutting-face part and the attachment projection are rounded. It is thereby possible to prevent a notch effect and crack formation in a particularly effective manner.

According to an embodiment, the cutting face comprises a coating, the hardness of which is greater than the hardness of the remaining cutting-face part. For example, the cutting face can comprise a diamond layer and a cutting-face part, except for the cutting face, made of hard metal. The coating is preferably made of poly-crystalline diamond (PCD). The hardness of the coating is preferably greater than the hardness of the remainder of the saw tooth. The coating can have any thickness.

The attachment projection also may at least partially comprise the coating. The attachment projection preferably does not have a coating, however, in order to permit a thoroughly wetting soldered joint to be established between the saw tooth and the saw blade body. If the attachment projection does not have a coating, it can be wetted with solder on the back side and on the underside and on the front side. The result thereof is a very strong connection between the saw tooth and the saw blade body. The coating can be removed by sharpening, laser processing or another suitable method.

In an embodiment, the saw tooth has a positioning recess and/or a positioning projection. The positioning recess and/or the positioning projection are formed on the attachment projection. By use of the positioning recess and the positioning projection, the saw tooth is easily connected to the saw blade body in an exact position. The positioning recess comprises beveled notches, slants, radii and/or other geometrical shapes.

The invention also relates to a saw blade comprising a saw blade body and at least one above-described saw tooth, wherein the saw tooth is attached in a saw tooth receptacle of the saw blade body. Preferably, a plurality of above-described saw teeth is attached to the saw blade body. The saw teeth may be distributed regularly or irregularly along a tooth-support region of the saw blade body. The saw tooth is preferably attached to the saw blade body by a clamped, bonded, soldered and/or welded connection.

The saw tooth receptacle may have a position projection that corresponds to the positioning recess and/or a position recess that corresponds to the positioning projection in order to allow the saw tooth to be oriented exactly relative to the saw blade body upon assembly.

According to an embodiment, the depth of the saw tooth receptacle in the cutting direction of the saw blade corresponds to the thickness of the cutting-face part and/or the thickness of the attachment projection. As a result, the saw tooth is fitted into the saw blade body as viewed in the cutting direction. The saw tooth is attached securely to the saw blade body by the contact on the front side and the back side of the saw tooth (both as viewed in the cutting direction) with the saw blade body. In addition, the saw tooth is attached to the saw blade body using a soldered, bonded and/or welded connection in order to obtain a very strong connection between the saw tooth and the saw blade body.

The depth of the saw tooth receptacle of the saw blade body in the cutting direction of the saw blade is greater than the thickness of the cutting-face part, however. This enables creating a chip space behind the saw tooth back, as viewed in the cutting direction. The front side of the saw tooth opposite the saw tooth back is thereby used, at least partially, as a surface for connection to the saw blade body. As an alternative, the saw tooth back is connected to the saw blade body, thereby producing a chip space in front of the front side of the saw tooth.

The saw blade is designed in the shape of a circular saw blade, an endless saw blade, a disk-shaped milling cutter, or a hacksaw blade.

### BRIEF DESCRIPTION OF THE DRAWINGS

Further features and advantages of the invention will become apparent from the description of embodiments that follows, with reference to the attached figures, wherein:

FIG. 1 presents a section of a front view of a first saw blade having a first saw tooth;

FIG. 2 presents a front view of a second saw tooth;

FIG. 3 presents a front view of a third saw tooth;

FIG. 4 presents a front view of a fourth saw tooth;

FIG. 5 presents a front view of a fifth saw tooth;

FIG. 6 presents a front view of a sixth saw tooth;

FIG. 7a presents a front view of a seventh saw tooth;

FIG. 7b presents a side view of the seventh saw tooth;

FIG. 7c presents a side view of an eighth saw tooth;

FIG. 7d presents a side view of a ninth saw tooth;

FIG. 7e presents a side view of a tenth saw tooth;

FIG. 7f presents a side view of an eleventh saw tooth;

FIG. 8a presents a section of a side view of a second saw blade having a twelfth saw tooth and a thirteenth saw tooth;

FIG. 8b presents a side view of the twelfth saw tooth, alone;

FIG. 9 presents a section of a side view of a third saw blade having a fourteenth saw tooth and a fifteenth saw tooth;

FIG. 10a presents a front view of a sixteenth saw tooth;

FIG. 10b presents a front view of a seventeenth saw tooth;

FIG. 10c presents a front view of an eighteenth saw tooth;

FIG. 11a presents a front view of a nineteenth saw tooth;

FIG. 11b presents a front view of a twentieth saw tooth; and

FIG. 12 presents a section of a side view of a fourth saw blade having a twenty-first saw tooth and a twenty-second saw tooth.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

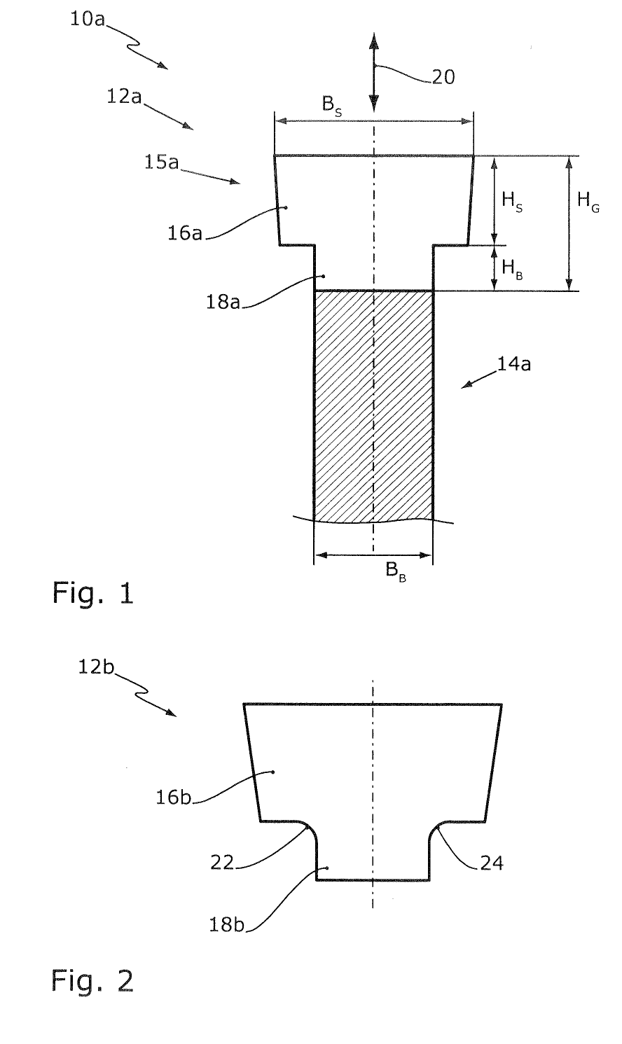

FIG. 1 shows a front view of a first saw blade 10a having a first saw tooth 12a. The first saw tooth 12a is attached to a saw blade body 14a. The saw blade body 14a is shown in an exposed view. The first saw tooth 12a comprises a cutting-face part 15a having a cutting face 16a. The cutting face 16a forms the front side of the cutting-face part 15a. An attachment projection 18a of the first saw tooth 12a adjoins the cutting-face part 15a. A double arrow 20 indicates the longitudinal direction of the first saw blade 10a and the first saw tooth 12a. The first saw tooth 12a extends away from the saw blade body 14a in the longitudinal direction.

The cutting face 16a has a height H_{S} in the longitudinal direction. Perpendicular to this height H_{S}, the cutting face 16a has a width B. The width B_{S} is more than twice as great as the height H_{S} of the cutting face 16a. As a result, the first saw tooth 12a can be securely attached to the saw blade body 14a without the possibility of the first saw tooth 12a being lifted off the saw blade body 14a due to leverage during sawing.

The first saw tooth 12a is attached to the saw blade body 14a on the back side of this first saw tooth, in the region of the cutting face 16a. The holding force of the first saw tooth 12a on the saw blade body 14a is further increased by the attachment projection 18a. The attachment projection 18a has a height H_{B} in the longitudinal direction and a width B_{B} perpendicular to the longitudinal direction. The overall height H_{G}, comprising the cutting-face height H_{S} and the attachment projection height H_{B}, is less than the width B_{S} of the cutting face 16a.

The width B_{B} of the attachment projection 18a is adapted to the width of the saw blade body 14a. In other words, the width B_{B} of the attachment projection 18a is identical to the width of the saw blade body 14a.

FIG. 2 shows a front view of a second saw tooth 12b, which substantially corresponds to the first saw tooth 12a according to FIG. 1. In contrast to the first saw tooth 12a, the second saw tooth 12b is rounded between a cutting face 16b and an attachment projection 18b. The roundings are indicated by reference signs 22 and 24. The roundings 22 and 24 minimize the risk of a crack forming due to a notch effect on the second saw tooth 12b.

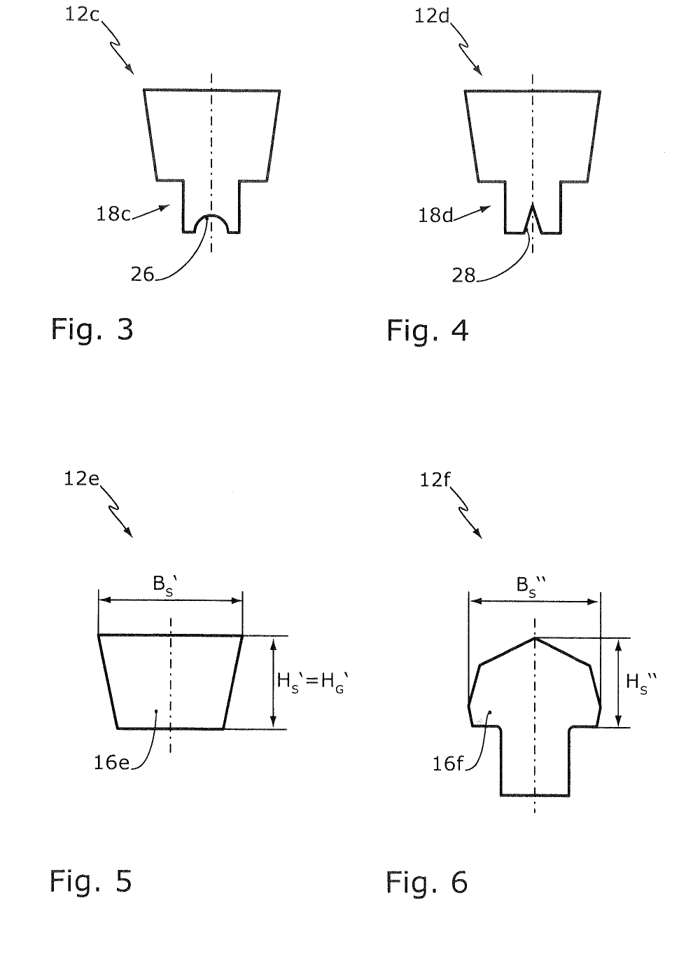

FIG. 3 shows a front view of a third saw tooth 12c, which has a round positioning recess 26 on an attachment projection 18c. The round positioning recess 26 is used to position and install the third saw tooth 12c relative to a saw blade body.

FIG. 4 shows a front view of a fourth saw tooth 12d having an attachment projection 18d. The attachment projection 18d comprises a notch-shaped positioning recess 28. The notch-shaped positioning recess 28 is used for the exact positioning of the fourth saw tooth 12d on an appropriate saw blade body.

FIG. 5 shows a front view of a fifth saw tooth 12e in the form of a flat tooth. A cutting face 16e of the fifth saw tooth 12e has a height H_{S}′, which is smaller than a width B_{S}′ of the cutting face 16e. The fifth saw tooth 12e does not have an attachment projection. The height H_{S}′ therefore corresponds to the overall height H_{G}′.

FIG. 6 shows a sixth saw tooth 12f in the form of a top tooth. A cutting face 16f of the sixth saw tooth 12f also has a greater width B_{S}″ than height H_{S}″.

Generally speaking, the saw tooth can have any suitable blade geometry, for example, also in the form of a trapezoidal tooth or an alternating direction tooth.

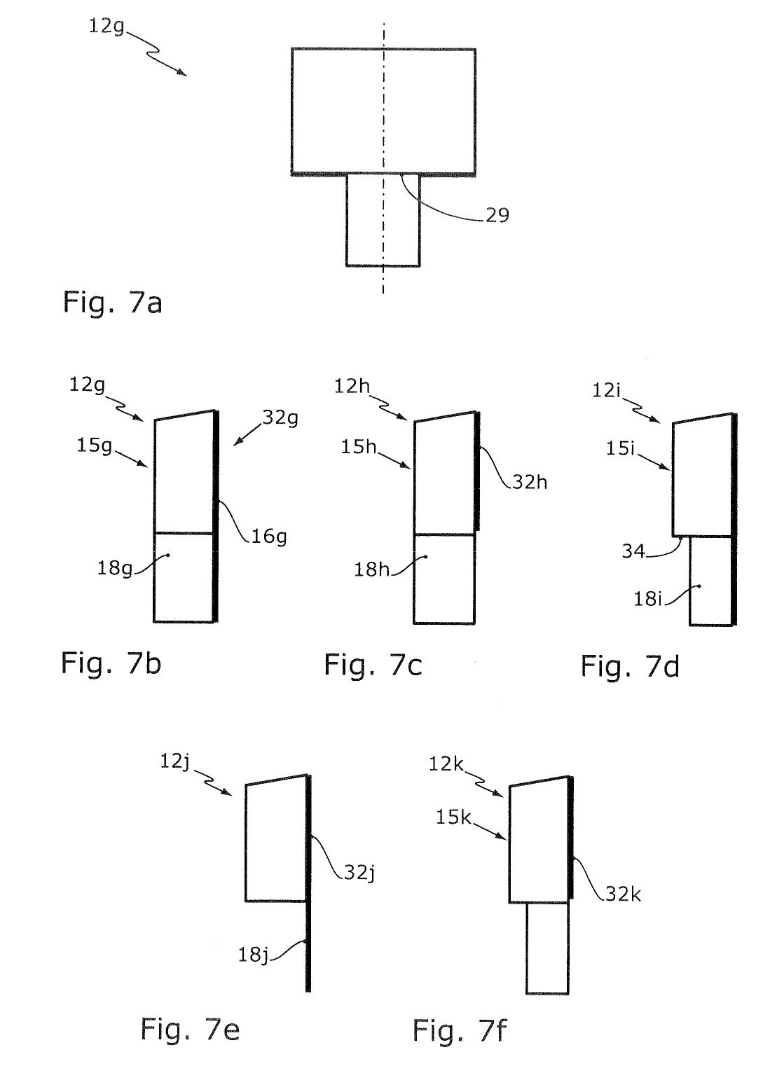

FIG. 7a shows a front view of a seventh saw tooth 12g. The front view of the saw tooth 12g corresponds to the front view of the saw teeth according to FIGS. 7b-7f, which are described in the following. A contour edge 29 is visible only in the front view corresponding to FIGS. 7c and 7f.

FIG. 7b shows the saw tooth 12g, in a side view. The saw tooth 12g comprises a cutting-face part 15g and an attachment projection 18g. The front side of the saw tooth 12g is provided with a coating 32g. The coating 32g extends over the front side of the cutting-face part 15g, i.e., over the cutting face 16g, and over the front side of the attachment projection 18g.

FIG. 7c shows a side view of a saw tooth 12h having a cutting-face part 15h, an attachment projection 18h and a coating 32h. The coating 32h is provided only on the front side of the cutting-face part 15h. The attachment projection 18h does not have a coating. As a result, the saw tooth 12h is easily soldered, welded and/or bonded to a corresponding saw blade body via the attachment projection 18h.

FIG. 7d shows a side view of a saw tooth 12i. The saw tooth 12i substantially corresponds to the saw tooth 12g according to FIG. 7b, wherein, in contrast to the attachment projection 18g, an attachment projection 18i is thinner on the back side thereof. A step 34 is thereby formed between the attachment projection 18i and a cutting-face part 15i. During sawing, the cutting-face part 15i bears against a saw blade body via the step 34. The loadability of the ninth saw tooth 12i during sawing is increased as a result.

FIG. 7e shows a saw tooth 12j, which substantially corresponds to the saw tooth 12l according to FIG. 7d. In the case of the saw tooth 12j, however, the thickness of an attachment projection 18j is reduced to the extent that only a coating 32j remains.

FIG. 7f shows a saw tooth 12k. The saw tooth 12k substantially corresponds to the saw tooth 12i according to FIG. 7d, wherein, in contrast to the saw tooth 12i, only one cutting-face part 15k has a coating 32k.

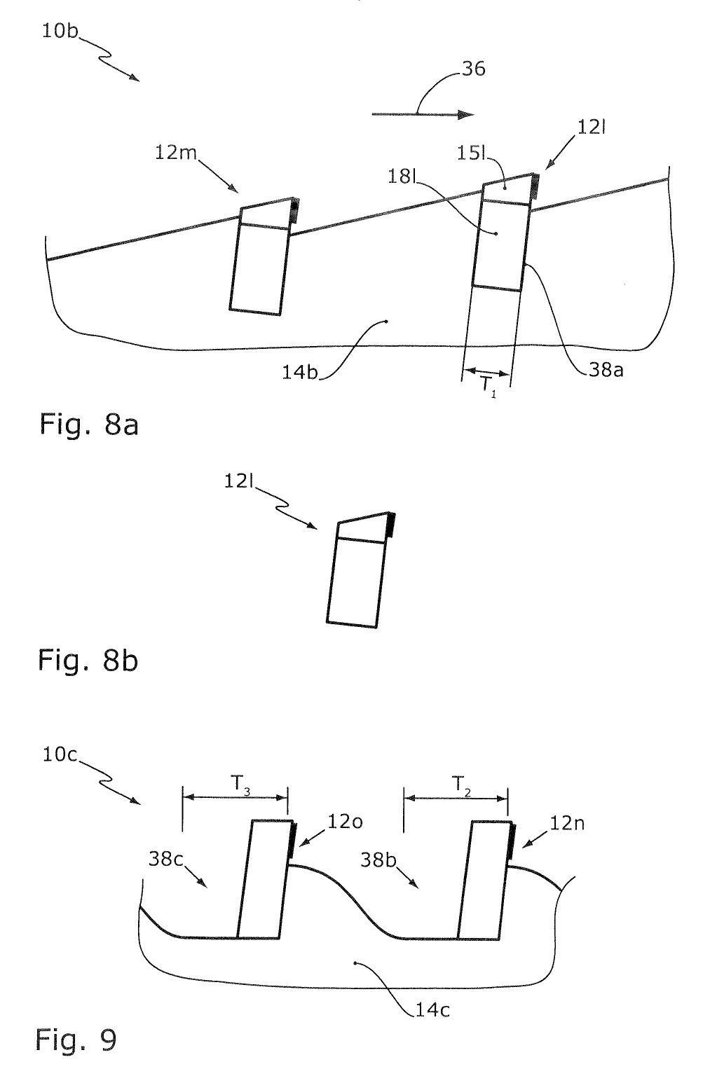

FIG. 8a shows a side view of a second saw blade 10b, in sections. The second saw blade 10b has a saw blade body 14b. A saw tooth 12l and a saw tooth 12m are attached to the saw blade body 14b. An arrow 36 indicates the cutting direction of the second saw blade 10b.

FIG. 8b shows the saw tooth 12l without the second saw blade 10b. A comparison of FIGS. 8a and 8b reveals that the saw tooth 12l according to FIG. 8a is anchored in the saw blade body 14b by a press fit. Likewise, the saw tooth 12m is anchored in the saw blade body 14b by a press fit, wherein the saw teeth 12l and 12m are identically designed. As an alternative or in addition to the attachment of the saw teeth by a press fit, one saw tooth 12l, 12m or all saw teeth 12l, 12m can be attached on the saw blade body 14b in another manner, such as by soldering, welding, and/or bonding.

A saw tooth receptacle 38a is provided in the saw blade body 14b, as shown in FIG. 8a, in order to accommodate the saw tooth 12l. The saw tooth receptacle 38a is substantially U-shaped. The depth of the saw tooth receptacle 38a is labelled with T₁. The depth T₁ of the saw tooth receptacle 38a corresponds to the thickness of a cutting-face part 15l and the thickness of an attachment projection 18l of the twelfth saw tooth 12l. As a result, the twelfth saw tooth 12l is securely held on the saw blade body 14b.

FIG. 9 shows a section of a side view of a third saw blade 10c having a saw blade body 14c. A saw tooth 12n and a saw tooth 12o are attached to the saw blade body 14c. The saw tooth 12n and the saw tooth 12o are identically designed. The saw blade body 14c has a saw tooth receptacle 38b and a saw tooth receptacle 38c. The depth of the saw tooth receptacle 38b is labelled with T₂, and the depth of the saw tooth receptacle 38c is labelled with T₃. T₂ and T₃ are greater than the thickness of the saw tooth 12n and the saw tooth 12o, respectively. The third saw blade 10c therefore has a chip space behind the saw tooth 12n and the saw tooth 12o, relative to the cutting direction.

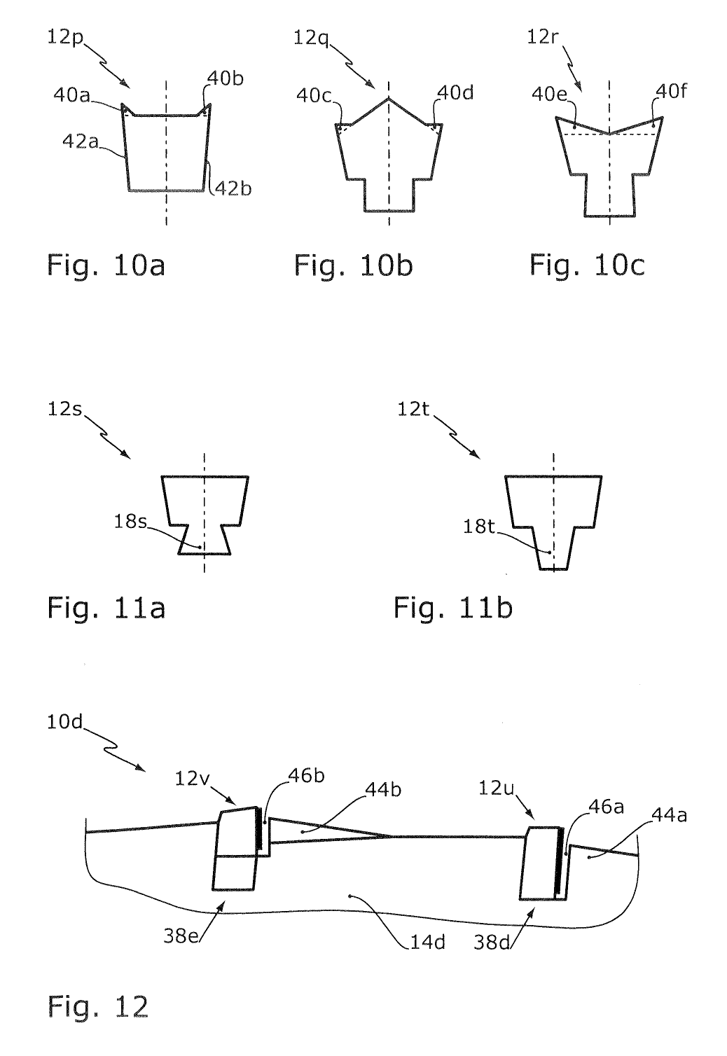

FIG. 10a shows a saw tooth 12p in a front view. In contrast to the previously described saw teeth, the saw tooth 12p has two measurement projections 40a, 40b. The measurement projections 40a, 40b result in an extension of the lateral faces 42a, 42b of the saw tooth 12p. The measurement projections 40a, 40b are used to accurately measure and adjust the position and angle of inclination (radial angle) of the lateral surfaces 42a, 42b while these undergo sharpening or erosion processing. Once the saw tooth 12p, as shown in FIG. 10a, is finished, the measurement projections 40a, 40b are removed along the broken lines and are no longer present on the “finished” saw tooth.

FIG. 10b shows a saw tooth 12q. The saw tooth 12q has measurement projections 40c, 40d to permit the geometry of this saw tooth to be accurately determined. Once the desired geometry, as shown, has been obtained, the measurement projections 40c, 40d are removed along the broken lines.

FIG. 10c shows a saw tooth 12r. The geometry of the saw tooth 12r is exactly determined and checked during production by measurement projections similar to those of FIGS. 10a and 10b, namely the measurement projections 40e, 40f in this case. Afterward, the measurement projections 40e, 40f are removed along the broken lines.

FIG. 11a shows a saw tooth 12s having an attachment projection 18s. The attachment projection 18s is wider toward the bottom, i.e., toward a saw blade body. The attachment projection therefore has a substantially dovetailed shape.

FIG. 11b shows a saw tooth 12t having an attachment projection 18t, which is narrower toward the bottom. The attachment projections 18s (see FIG. 11a) and 18t are particularly well-suited for attaching the saw teeth 12s (see FIG. 11a) and 12t in correspondingly designed saw tooth receptacles.

Generally speaking, the attachment projection of a saw tooth can have a non-parallel course relative to a central plane of a saw blade body, as made evident in FIGS. 11a and 11b, as examples.

FIG. 12 shows a section of a side view of a fourth saw blade 10d having a saw blade body 14d. A saw tooth 12u and a saw tooth 12v in saw tooth receptacles 38d, 38e are attached to the saw blade body 14d. In contrast to the previously described saw blade bodies, the saw blade body 14d comprises a raised area 44a, 44b in front of each of the saw tooth receptacles, namely the saw tooth receptacles 38d, 38e in this case, as viewed in the cutting direction. The raised areas 44a, 44b reduce the load on the saw teeth 12u and 12v. The raised area 44b is slanted on one side, toward the central plane of the saw blade body 14d. As an alternative, the raised area 44b is slanted on both sides, toward the central plane of the saw blade body 14d, or has a bevel.

In the representation shown in FIG. 12, the raised areas 44a, 44b have a gap 46a, 46b, respectively, relative to the saw teeth 12u, 12v. It is also feasible, however, to not provide a gap between the raised areas 44a, 44b and the saw teeth 12u, 12v, respectively.

Generally speaking, such a radial raised area of the saw blade body in front of a saw blade receptacle can be used in combination with any previously described saw tooth.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A saw tooth for a saw blade is attached in a longitudinal direction on the saw blade body to extend away, at least in part, from the saw blade body, the, saw tooth comprising:
a cutting-face part having a cutting face with a height (H_{S}, H_{S}′, H_{S}″) extending in the longitudinal direction and a width (B_{S}, B_{S}′, B_{S}″) extending perpendicularly to the longitudinal direction,
wherein the width (B_{S}, B_{S}′, B_{S}″) of the cutting face is greater than the height (H_{S}, H_{S}′, H_{S}″) of the cutting face.

2. The saw tooth according to claim 1, further comprising an attachment projection, which extends away from the cutting face in the longitudinal direction.

3. The saw tooth according to claim 2, wherein the attachment projection is larger in the longitudinal direction than the height (H_{S}, H_{S}′, H_{S}″) of the cutting face.

4. The saw tooth according to claim 2, wherein a width (BB) of the attachment projection is smaller than the width (B_{S}, B_{S}″) of the cutting face.

5. The saw tooth according to claims 2, wherein the saw tooth has a thickness extending perpendicularly to the height (H_{S}, H_{S}′, H_{S}″) of the cutting face and perpendicularly to the width (B_{S}, B_{S}′, B_{S}″) of the cutting face and wherein the thickness of the cutting-face part corresponds to a thickness of the attachment projection.

6. The saw tooth according to claim 2, wherein the thickness of the cutting-face part is greater than the thickness of the attachment projection.

7. The saw tooth according to claim 2, wherein at least one transition between the cutting-face part and the attachment projection is rounded.

8. The saw tooth according to claim 7, wherein all transitions between the cutting-face part and the attachment projection are rounded.

9. The saw tooth according to claim 1, wherein the cutting face comprises a coating having a hardness that is greater than a hardness of a remainder of the cutting-face part.

10. The saw tooth according to claim 9, wherein the attachment projection does not have a coating.

11. The saw tooth according to claim 1, wherein the attachment projection comprises a positioning recess, a positioning projection or both.

12. A saw blade comprising:
a saw blade body; and
at least one saw tooth attached in a longitudinal direction on the saw blade body to extend away, at least in part, from the saw blade body and formed with a cutting-face part having a cutting face with a height (H_{S}, H_{S}′, H_{S}″) extending in the longitudinal direction and a width (B_{S}, B_{S}′, B_{S}″) extending perpendicularly to the longitudinal direction,
wherein the width (B_{S}, B_{S}′, B_{S}″) of the cutting face is greater than the height (H_{S}, H_{S}′, H_{S}″) of the cutting face; and.
wherein the saw tooth is attached in a saw tooth receptacle of the saw blade body.

13. The saw blade according to claim 12, wherein the attachment projection comprises a positioning recess, a positioning projection or both and wherein the saw tooth receptacle comprises a position projection corresponding to the positioning recess, a position recess corresponding to the positioning projection or both.

14. The saw blade according to claim 1, wherein a depth (T₁) of the saw tooth receptacle corresponds, in a cutting direction of the saw blade, to the thickness of the cutting-face part, the thickness of the attachment projection or both.

15. The saw blade according to claim 12, wherein a depth (T₂, T₃) of the saw tooth receptacle is greater, in the cutting direction of the saw blade, than the thickness of the cutting-face part.

16. The saw blade according to claim 12, wherein the saw blade is a circular saw blade, an endless saw blade, a disk-shaped milling cutter, or a hacksaw blade.
